(19) United States
(12) Patent Application Publication
(10) Pub. No.: US 2012/0318778 A1
(43) Pub. Date: Dec. 20, 2012

(54) WELDING GUN CLIP AND METHOD OF USE

(76) Inventor: ROGER JOUBERT, Cypress, TX (US)

(21) Appl. No.: 13/332,183

(22) Filed: Dec. 20, 2011

Related U.S. Application Data
(60) Provisional application No. 61/424,721, filed on Dec. 20, 2010.

(51) Int. Cl. B23K 9/28; B23P 23/00

(52) U.S. Cl. 219/137.44; 29/401.1

(57) ABSTRACT

A welding gun clip assembly for converting a manual welding gun to a continuous or automated operation comprising: a conventional welding gun, where said gun includes at least a wire feed, a gun handle, a trigger along the gun handle and a welding tip, where the trigger includes a depressed position and an open position; and an attachable clip, where said clip extends around the gun handle and is movable to secure the trigger in a depressed position.

### CROSS REFERENCE TO OTHER APPLICATIONS

This application claims priority to U.S. Provisional Application Ser. No. 61/424,721 filed on Dec. 20, 2011.

### BACKGROUND OF THE INVENTION

1. Field of Invention

The present invention relates to a welding gun clip that provides a means to automate a conventional welding gun.

2. Description of Related Art

Arc welding is the process of applying a heated metal bead to join two metal pieces. This process is performed by using a welding gun that includes a wire feed, an electrical powered electrode, a wire and a shielding gas supply. An arc-welding gun includes a number of parts the control switch, a contact tip, a power cable, a gas nozzle, an electrode conduit and liner and a gas hose. The control switch or trigger initiates the feeding of wire to the gun and activates the electrical power and flow of shielding gas. The combination thereof causes an electrical arc to be struck. During the process of performing the gas metal arc welding an operator guides the welding gun into the proper position for application of the welding bead. The operation of the welding gun requires the depression of a trigger of the gun and a supply of shielding gas. A typical welder must wear protective clothing such as heavy leather gloves, long protective leather sleeve jackets to avoid exposure to the heat and flames that are associated with the welding process. Further the welder must also wear eye protection to avoid irritation of the eyes due to the ultraviolet light that is transmitted during the welding process.

As stated above, the welder depresses the trigger throughout the welding process in order to initiate the wire feed and electrode. Although some continuance welding guns are available that provide a continuous wire stream such equipment is expensive and may require the purchasing of a new wire feed for the welding machine. It would therefore be advantageous to have a device that converts a manual welding gun into a automatic continuous feeding gun through the use of an additional attachment device.

### SUMMARY OF THE INVENTION

The present invention relates to a welding gun clip assembly for converting a manual welding gun to a continuous or automated operation comprising: a conventional welding gun, where said gun includes at least a wire feed, a gun handle, a trigger along the gun handle and a welding tip, where the trigger includes a depressed position and an open position; and an attachable clip, where said clip extends around the gun handle and is movable to secure the trigger in a depressed position.

### BRIEF DESCRIPTION OF DRAWINGS

FIG. 1 depicts a welding gun clip assembly according to the present invention.

### DETAILED DESCRIPTION

The present invention relates to a welding gun clip that converts a manual welding gun into a continuous wire feed welding gun through the application of a clip onto the trigger of the welding gun. Use of the welding gun clip according to the present invention transforms the manual wire feed welder into a more enhanced and expensive version of an electronic controlled continuous wire feed welder.

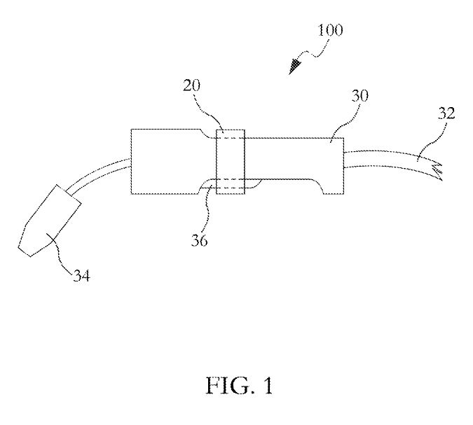

In reference to FIG. 1, a welding gun/Clip Assembly 100 is depicted. The Clip Assembly 100 includes a Welding Gun 30 that has electronic wire Feed 32 along with a Gun Tip 34. A Welding Gun 30 further includes a Trigger 36. The Trigger 36 is depressed in order to activate and operate the welding gun. A Clip Assembly 20 is provided which wraps around the Welding Gun 30 and provides a means to place the Trigger 36 in a depressed position. While in its depressed position the Gun 30 provides a continuous feed of wire for application. The Clip 20 snuggly fits around the outside of gun and around the outside of the Trigger 36 to maintain the Trigger 36 in a depressed position.

The welding gun Trigger Clip 20 reduces the amount of energy and concentration needed to operate a conventional welding gun. Via the insertion and application of the Trigger Clip 20 the welding gun is converted into a continuous wire feed welding machine. The Clip 20 may be removed once the welding is complete and stored for use at a later time with a welding gun. The present invention helps a user to utilize the welding gun in a shallow or tight spot by keeping the trigger in an on position for an extended amount of time. It further allows the welder to switch from a manual welding machine to a continuous feed machine without any complicated equipment changes. The instant invention has been shown and described in what it considers to be the most practical and preferred embodiments. It is recognized, however, that departures may be made there from within the scope of the invention and that obvious modifications will occur to a person skilled in the art.

What is claimed is:

1. A welding gun clip assembly for converting a manual welding gun to a continuous or automated operation comprising:
a. a conventional welding gun, where said gun includes at least a wire feed, a gun handle, a trigger along the gun handle and a welding tip, where the trigger includes a depressed position and an open position; and
b. an attachable clip, where said clip extends around the gun handle and is movable to secure the trigger in a depressed position.

2. A method of converting a manual welding gun to continuous operation comprising the steps of:
a. inserting a clip over a gun handle of the welding gun;
b. moving the clip in contact with a trigger extending from the gun handle;
c. continuing to move the clip in contact with the trigger until the trigger is in a depressed position and welding gun operates continuously;
d. allowing continuous operation of the welding gun;
e. removing the clip from the trigger after complete of welding function to place the trigger in an open position.
